(19) United States
(12) Patent Application Publication
(10) Pub. No.: US 2010/0323603 A1
(43) Pub. Date: Dec. 23, 2010

(54) Ventilation air assembly

(76) Inventor: Erik Lans, Trosa (SE)

Correspondence Address: HARNESS, DICKEY & PIERCE, P.L.C., P.O. BOX 8910, RESTON, VA, 20195, US

(21) Appl. No.: 12/449,690

(22) PCT Filed: Feb. 20, 2008
(86) PCT No.: PCT/EP2008/052089

§ 371 Date: Apr. 8, 2010

(30) Foreign Application Priority Data
Feb. 22, 2007 (SE) 0700426-0

(51) Int. Cl. E06B 7/02; F24F 13/10; B01D 46/42

(52) U.S. Cl. 454/196; 454/322; 55/496

(57) ABSTRACT

One embodiment of the present invention relates to a ventilation air assembly, including a filter holding unit the filter holding unit includes a housing having an inlet for ventilation air and an outlet for ventilation air, and a control member for controlling a ventilation air flow through the outlet. The filter holding unit is mounted at the wall surface. Furthermore, the ventilation air assembly includes a filter, which is arranged in the housing of the filter holding unit such that the ventilation air passes through the filter when flowing through the housing from the inlet to the outlet. Furthermore, the ventilation air assembly includes a wall portion having a wall surface, and a heater device, such as a radiator, which is mounted at the wall surface. The filter holding unit and the heater device are such positioned relative each other and the wall surface, and the control member is such adjustable, that the ventilation air flow exiting the outlet is directed towards a space between the wall surface and the heater device. The embodiment of the present invention does also relate to a filter holding unit for use in such a ventilation air assembly.

### TECHNICAL FIELD OF THE INVENTION

The present invention relates to a ventilation air assembly and to a filter holding unit for such a ventilation air assembly.

### BACKGROUND ART

WO99/06775 discloses ventilator which is adapted to be placed adjacent a window in a wall. The ventilator is intended to be placed in a ventilation path between two sides of the widow or wall. The ventilator is an elongated device, which is mounted horizontally in the wall. Inside the ventilator, a barrier wall is arranged, which is provided with a series of apertures along the length thereof. A rotatable flap is pivotally mounted at the barrier wall, which flap can be pivoted between a position where the flap blocks airflow through the apertures, and a position where air is allowed to pass the flap and flow thorough the apertures. Before the barrier wall, as seen in the direction of the air flow through the ventilator, the ventilator comprises a weather hood. On the other side of the barrier wall, the ventilator comprises a cover portion of generally C-shaped cross section. The C-shaped cover portion forms a filter chamber inside the housing for holding a filter for filtering air passing through the ventilator. The cover portion is further provided with a series of ventilation apertures arranged in a honeycomb distribution. The cover portion is removably arranged at the barrier wall such that the entire cover portion can be removed from the ventilator and put down off the ventilator taking the filter with it. When the cover portion is removed from the ventilator, the filter arranged in the cover portion can be exchanged.

A problem with this known ventilator is that it can not be mounted in an existing wall without having to cause extensive damage to the wall. This has also the effect that it is complicated and time consuming to mount the ventilator. Another problem with this known ventilator is that the ventilation air flow exiting the ventilator sometimes is experienced as draught.

WO98/36223 discloses a device leading in ventilation air. The device comprises a box which is fitted with an inclined filter. At a first side of the filter, the box is provided with an air intake which is connected to an outdoor air duct. At the air intake, there is a damper for controlling the incoming air volume. At a second side of the filter, the box is provided with a hole through which filtered air is released. The box is positioned in a space between a heater device and a wall surface.

A problem with this known device is that, if at all possible, it is cumbersome to mount the device after a heater device once has been installed. Another problem is that an air duct has to be provided through the wall close to the device, which may not be a preferred location with regard to wall damages.

### SUMMARY OF THE INVENTION

It is therefore an object of the present invention to provide an arrangement which alleviates at least some of the above-mentioned problems.

According to the invention, this object is achieved by the ventilation air assembly according to claim 1 and by the filter holding unit according to claim 16.

The ventilation air assembly according to the invention comprises a filter holding unit. The filter holding unit comprises a housing having an inlet for ventilation air and an outlet for ventilation air, and a control member for controlling a ventilation air flow through the outlet. The ventilation air assembly comprises a filter, which is arranged in the housing of the filter holding unit such that the ventilation air passes through the filter when flowing through the housing from the inlet to the outlet. Furthermore, the ventilation air assembly comprises a wall portion having a wall surface, and a heater device, such as a radiator, which is mounted at the wall surface. The filter holding unit is also mounted at the wall surface. The filter holding unit and the heater device are such positioned relative each other and the wall surface, and the control member is such adjustable, that the ventilation air flow exiting the outlet is directed towards a space between the wall surface and the heater device.

Due to the construction of the ventilation air assembly, the filter holding unit is mountable at a wall surface, which causes no substantive damage to the wall as compared to the mounting of the described prior art ventilator, which is integrated into a wall. The inlet of the filter holding unit can be brought into fluid connection with any desired ventilation air flow. Thus, the wall can be provided with one or several air channels, which have a size and location that causes as little damage to the wall as possible. Furthermore, due to the position of the filter holding unit at the wall surface and the construction of the control member, the ventilation air flow exiting the outlet is directed in a favourable direction, which is towards the space between the heater device and the wall surface. Thereby the ventilation air is heated before it enters the room, which reduces the risk for experiencing the ventilation air flow as draught, increases the comfort of the room, and reduces the heating costs.

According to the invention, the housing of the filter holding unit can have any suitable shape and form to fit the local conditions of available space on the wall surface at the heater device, required filter size and required volume of ventilation air. The housing can have one or several open sides, for example a wall facing side or the side of the inlet or outlet. The housing can for example have an overall shape of an elongated cuboid for housing an elongated filter.

According to the invention, the inlet and the outlet can be provided at any suitable sides of the housing, for example, the inlet at a top side or at a top end of a wall facing back side, and the outlet at bottom side or at a bottom end of said back side.

According to the invention, the filter can be of any suitable size and quality, for example a HEPA filter. The size of the filter is normally adapted to the size of the filter holding unit.

According to the invention, the heater device can be of any suitable kind, for example a radiator or an electric heater.

According to the invention, the control element can be arranged to redirect the ventilation air flow before, in or after the outlet.

According to the invention, the control member, which is adjustable, can be constructed in many different ways. Thus, the control member can be constructed to stationary direct the air flow in one direction only, or such that the direction of the ventilation air flow exiting the outlet is adjustable. Alternatively or in addition, the control member can be constructed to affect the flow volume of the ventilation air flow exiting the outlet.

According to the invention, the filter holding unit and the heater device are such positioned relative each other that the heater device overlaps at most a minor portion of the filter holding unit. Normally, the filter holding will be located closer to the wall surface than the heater device. If there is an overlap and the filter holding unit is mounted closer to the wall surface than the heater device, said minor portion of the heater device then extends into the space between the heater device and the wall surface. Thanks to the control member, the ventilation air flow exiting the outlet can be directed towards this space although a major portion of the filter holding unit is located outside the heater device. However, according to the invention, it is also possible to mount the heater device closer to the wall surface than the filter holding device.

According to the invention, the filter holding unit can be mounted in many different positions relative the heater device. The filter holding unit and the heater device can be positioned relative each other without any overlapping portions at all. Thereby it is easy to mount the filter holding unit even if the heater device has been installed earlier. For example, the filter holding unit can be mounted over the heater device, wherein the ventilation air flow is directed downwards. Alternatively, the filter holding unit can be mounted to one side of the heater device, wherein the ventilation air flow is directed sideways. Another alternative is to mount the filter holding unit below the heater device, wherein the ventilation air flow is directed upwards.

According to one embodiment of the invention, the control member comprises an adjustable guide element, for example a pivotable mounted flap-like element, which forces the ventilation air flow to flow in the desired direction. The guide element can be given an aerodynamically adapted shape, for example a curved or semicircular cross section.

According to another embodiment, the control member comprises a stationary nozzle, which is mounted in the housing such that, from the position of the outlet of the filter holding unit at the wall surface, the ventilation air flow is directed towards the space between the heater device and the wall surface. In addition, the nozzle can be provided with a valve or throttle for regulating the volume of ventilation air passing through the outlet.

According to one embodiment of the invention, the control member is adjustable such that the ventilation air flow through the outlet is blocked.

According to one embodiment of the invention, the housing is provided with a filter exchange opening and with a closure member for closing the filter exchange opening. The filter opening extends at a front side of the filter housing along substantially the whole length of the filter. Thereby, the opening has such a size that the filter can be easily accessed for changing thereof. Filter changing is even more facilitated in an embodiment where the closure member is pivotable arranged at the housing. Thereby the closure member can easily be brought in position where the entire opening and the filter behind are exposed, while still being attached to the housing. Thus, the closure member needs not be put down when the filter is exchanged, which troublesome regarding larger filter holding units and which also relives the user of the trouble of aligning the closure member again for closing the opening after the filter has been exchanged.

According to one embodiment of the invention, the control member is formed as a pivotable arranged flap, the filter exchange opening is arranged at the front side of the housing and the front wall of the housing forms the closure member of the filter exchange opening, wherein the front wall/closure member is pivotable arranged at the housing. According to one such embodiment, the pivot axes of the flap and the front wall/closure member coincide. This embodiment is advantageous in that it provides a simple, cost efficient construction.

According to one embodiment of the invention, the housing of the filter holding unit is an elongated box extending horizontally along the wall surface and the filter is an elongated filter body extending horizontally in the housing. The housing can be produced from standardized profiles, for example aluminium profiles. Thus, the housing can be produced in a few standard lengths only, which are cut into the appropriate lengths prior mounting on the wall surface. Furthermore, aluminium profiles have the advantage that they can relatively easy be provided with different appealing surface structures. Consequently, the filter holding unit can easily be adapted to fit different conditions and preferences.

### BRIEF DESCRIPTION OF THE DRAWINGS

The invention may be performed in many various ways, and by way of example only, an embodiment thereof will now be described in detail with reference being made to the accompanying drawings in which,

FIG. 1 is a schematic front view of the ventilation air assembly according to an embodiment of the invention arranged below a window;

FIG. 2 is a schematic sectional view of the embodiment shown in FIG. 1;

FIG. 3 is a schematic sectional view at an end potion of the embodiment shown in FIG. 1, where air flow through the outlet is blocked;

FIG. 4 is a schematic sectional view at an end potion of the embodiment shown in FIG. 1, where air flow through the outlet is directed to a space between a heater device and a wall surface; and

FIG. 5 is a schematic perspective, partly exploded view of the filter holding unit with inserted filter according to an embodiment of the invention.

### DETAILED DESCRIPTION OF A PREFERRED EMBODIMENT OF THE INVENTION

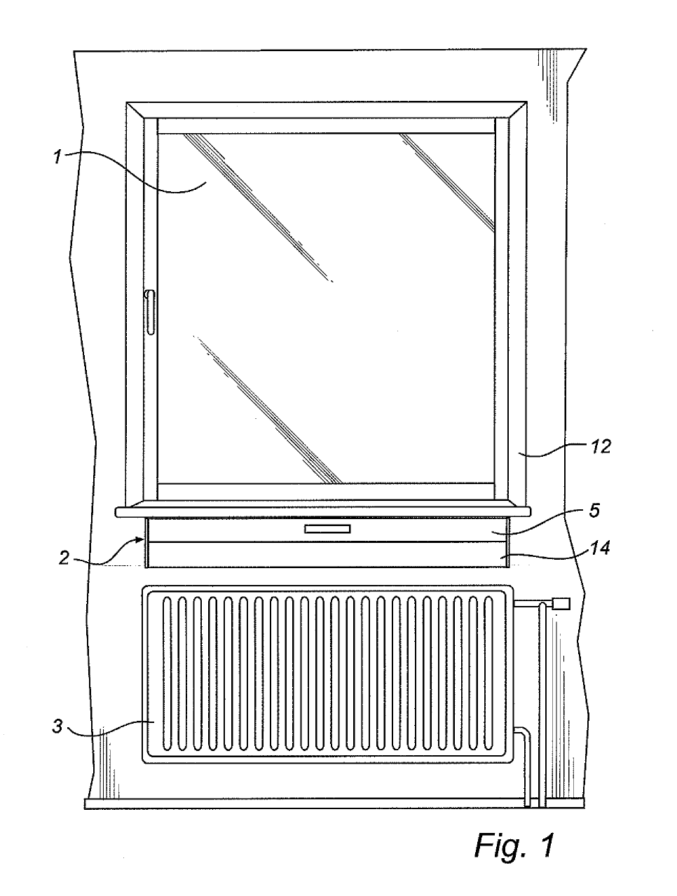

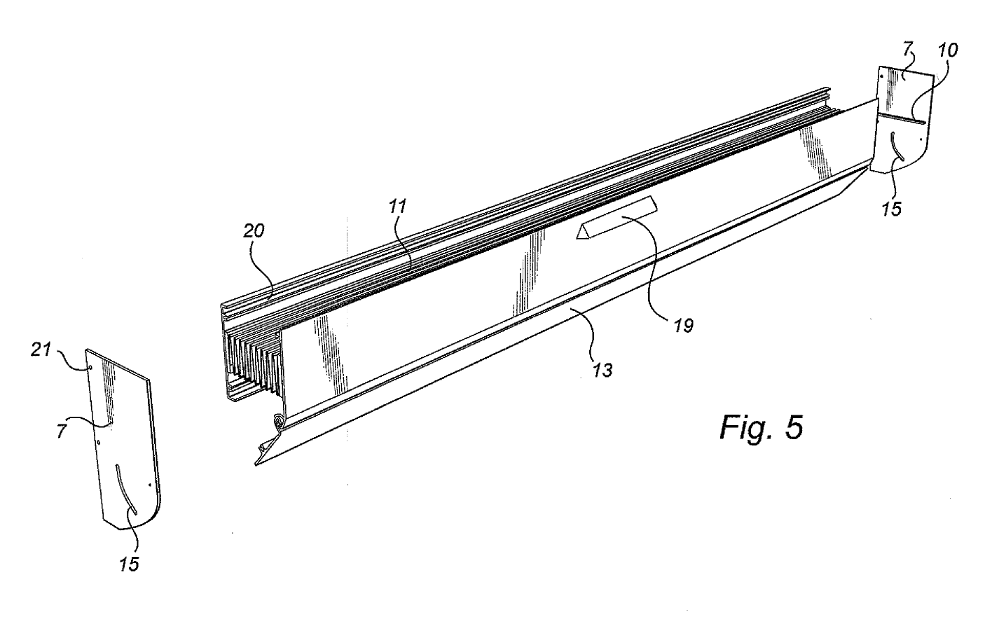

In FIGS. 1, 2 and 5 the general disposition of a ventilation air assembly and a filter holding unit according to an example embodiment is shown. The ventilation air assembly comprises a wall portion 4 with a window 1, a filter holding unit 2 and a heater device in form of a radiator 3. The filter holding unit 2 is mounted at a surface of the wall portion below and adjacent the window 1, wherein it extends horizontally along the wall. The radiator 3 is mounted below the filter holding unit 2.

The filter holding unit 2 comprises an elongated box-like housing, which is composed of aluminium profiles. Thus, the housing comprises a front wall 5, a back wall 6, and two side walls 7. The housing has an inlet 8 for ventilation air in form of an open top side and an outlet 9 for ventilation air in form of an open bottom side.

The housing is provided with a filter holding device, which comprises support edges 10 arranged at the back wall 6 and at the two side walls 7. An elongated filter body 11 is inserted in the housing, wherein the filter body 11 rests on the support edges 10.

The window 1 comprises a window frame 12, in which a ventilation air channel 13 is provided. The ventilation air channel 13 is in fluid connection with the inlet 8.

At the outlet 9, a control member in form of a flap 14 is arranged. The flap 14 is pivotable round a pivot axis 17 at the front end of the outlet. To this end, the flap 14 is connected to the two side walls 7 by a pivot pin (not shown) which is aligned with the pivot axis. The flap is further provided with screw channel 16, which extends longitudinally on the inside of the flap. At least one of the two side walls 7 are provided with an arc-shaped groove 15. A locking screw (not shown) is to be inserted through the groove 15 in the at least one of the two side walls 7 for engagement with the screw channel 16 on the flap 14.

The front wall 5 is pivotable attached to flap 14, wherein the pivot axis 17 of the front wall 5 and the flap 14 coincide. Thus, the front wall is attached to the two side walls 7 at the pivot axis 17. At an upper end, the front wall 5 is on the inside provided with a rail 18 for positive snapping engagement with a corresponding open sleeve (not shown) at least one of the side walls 7. A handle 19 is provided on the outside of the front wall 5.

Finally, the two side walls 7 are mounted to the back 6 wall by means of screws inserted through screw holes 21 and engaging screw channels 20 at the and back walls 6.

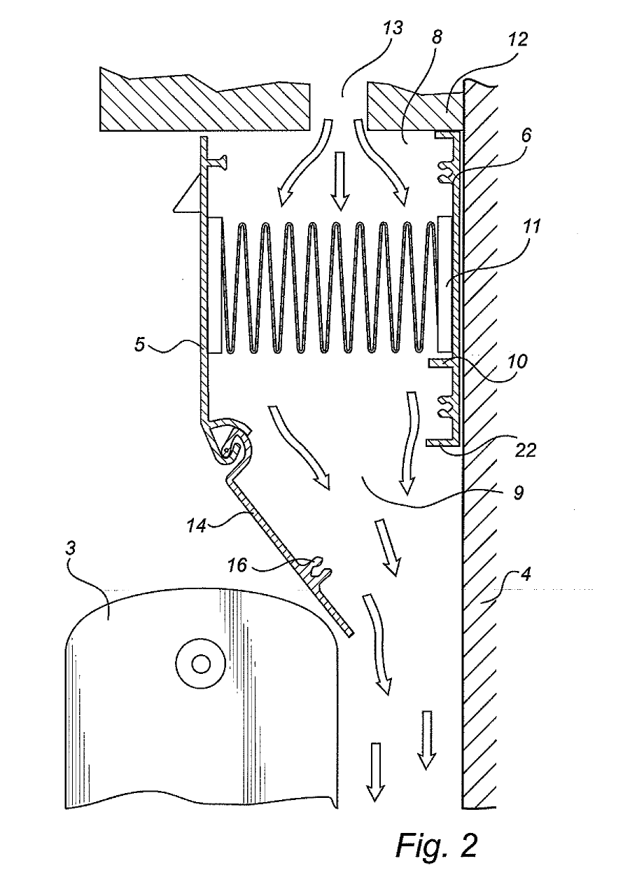

The ventilation air assembly according to the invention can be operated in the following way. Ventilation air arriving through the air cannel 13 enters the housing of the filter holding unit 2 through the inlet 8. The ventilating air flows through the housing towards the outlet 9 passing through the filter body 11. In the position shown in FIGS. 2 and 4, the flap is in an open position allowing the exit of ventilation air through the outlet 9. Due to the relative position of the filter holding unit 2 and the radiator 3, and the construction of the flap, ventilating air is directed towards a space between the wall surface and the radiator 2. Thus, the ventilating air is heated by the radiator before the air is distributed in the room. The area of the outlet 9, or in other words, the volume of ventilating air exiting through the outlet, is adjustable by releasing the locking screw (not shown), pushing the locking screw upwards or downwards in the groove 15 such that the flap 14 is pivoted towards or away from the outlet 8, and, when the flap 14 is in the desired position, tighten the locking screw again.

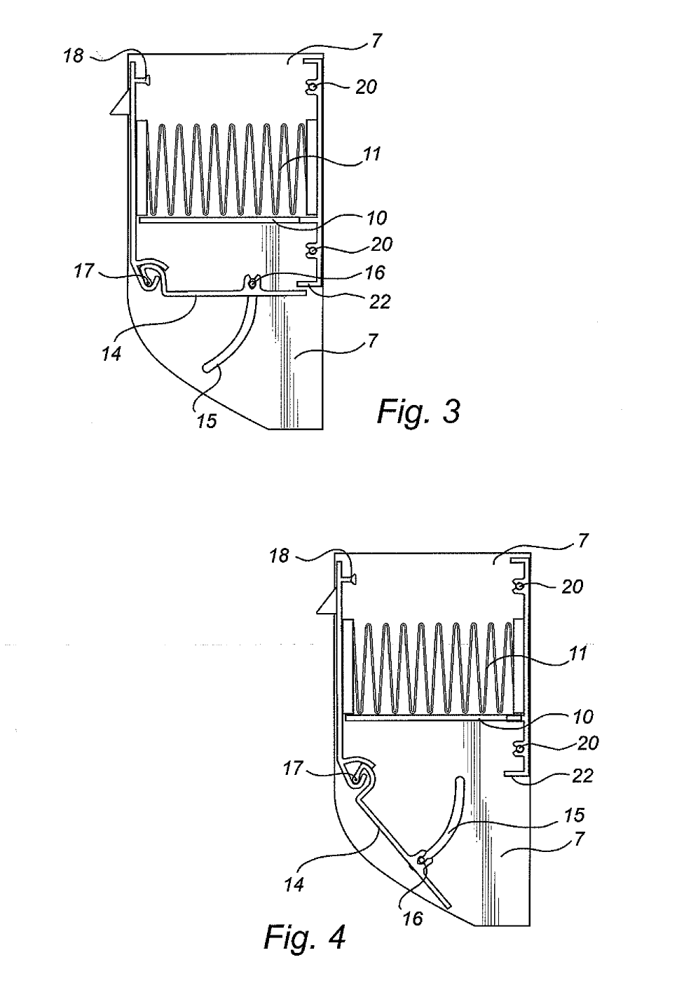

As shown in FIG. 3, the flap can be brought into contact with a flange 22 at the back wall 6 such that the outlet is blocked. In this position, no or only little ventilating air flow will exit the outlet 8. Thus, the ventilating air flow can be shut off, if desired. Optionally, the flange 22 and/or a portion round the outlet 9 can be provided with a sealing for minimizing the any air leakage through the outlet when the flap is in the closed position of FIG. 3.

When the ventilation air assembly according to the invention has been in use a certain time, it may be necessary to exchange the filter body. For this purpose, an operator can pull the handle 19 of the front wall 5 such that the snapping engagement between the rail 18 and the sleeve is released. Then, the operator can pivot the front wall, which thus also functions as a closure member, downwards to expose a filter exchange opening. Then the filter can easily be lifted from the support edges 10, be removed through the exchange opening and disposed of. Finally, a fresh filter can be inserted in the housing and the front wall 5 can be closed.

1. A ventilation air assembly, comprising
a filter holding unit, which comprises a housing having an inlet for ventilation air and an outlet for ventilation air, and a control member for controlling a ventilation air flow through the outlet,
a filter, which is arranged in the housing of the filter holding unit such that the ventilation air passes through the filter when flowing through the housing from the inlet to the outlet,
a wall portion having a wall surface,
a heater device, such as a radiator, which is mounted at the wall surface, wherein
the filter holding unit is mounted at the wall surface,
the filter holding unit and the heater device are such positioned relative each other that the heater device overlaps at most a minor portion of the filter holding unit, and wherein
the filter holding unit and the heater device are such positioned relative each other and the wall surface, and the control member is such adjustable, that the ventilation air flow exiting the outlet is directed towards a space between the wall surface and the heater device.

2. The ventilation air assembly according to claim 1, wherein the filter holding unit and the heater device are positioned relative each other without overlapping portions, wherein the filter holding unit preferably is mounted over, below or to one side of the heater device.

3. The ventilation air assembly according to claim 1, wherein the control member is adjustable such that the ventilation air flow through the outlet is blocked.

4. The ventilation air assembly according to claim 1, wherein the control member is arranged to control the direction of the ventilation air flow exiting the outlet.

5. The ventilation air assembly according to claim 1, wherein the control member is arranged to control air flow volume.

6. The ventilation air assembly according to claim 1, wherein the control member is arranged to be continuously adjustable and lockable in all positions thereof.

7. The ventilation air assembly according to claim 1, wherein the control member is a flap-like element, which is pivotably arranged about a pivot axis at the outlet.

8. The ventilation air assembly according to claim 1, wherein the housing is an elongated box extending horizontally along the wall surface, the filter is an elongated filter body extending horizontally in the housing.

9. The ventilation air assembly according to claim 7, wherein the hosing is provided with a bottom wall at a bottom side, the outlet is provided at the bottom side, and wherein the flap-like element forms at least a major part of the bottom wall.

10. The ventilation air assembly according to claim 8, wherein the housing has a front side opposite the wall surface, the housing is provided with a filter exchange opening, which extends at the front side at least along a major portion of the filter body, and with a closure member for closing the filter exchange opening.

11. The ventilation air assembly according to claim 10, wherein the housing is provided with a front wall at the front side, and wherein the closure member forms at least a major part of the front wall.

12. The ventilation air assembly according to claim 10, wherein the closure member is piovotably arranged about a pivot axis at the housing.

13. The ventilation air assembly according to claim 7, wherein the pivot axis of the flap-like element and the pivot axis of the closure member coincide.

14. The ventilation air assembly according to claim 1, wherein the wall portion includes a window, the filter holding unit is mounted below the window and wherein the heater device is mounted below the filter holding unit.

15. The ventilation air assembly according to claim 14, wherein the window is mounted in the wall portion by a window frame, the wall portion is provided with a ventilation air channel, which at least partly extends through the window frame and which is in fluid connection with the inlet.

16. A filter holding unit for use in a ventilation air assembly according to claim 1, comprising
a housing having an inlet for ventilation air and an outlet for ventilation air, and
a control member for controlling a ventilation air flow through the outlet, wherein
the housing is adapted to receive a filter for cleaning ventilation air flowing through the housing from the inlet to the outlet, and wherein
the housing is adapted to be mountable at a wall surface, and wherein
the control member is adjustable to control the direction and the volume of ventilation air exiting through the outlet.
